(19) United States
(12) Patent Application Publication
(10) Pub. No.: US 2010/0125879 A1
(43) Pub. Date: May 20, 2010

(54) METHOD AND APPARATUS FOR PURCHASING A SOUNDTRACK WHEN VIEWING A MOVIE OR OTHER PROGRAM DELIVERED BY A CONTENT DELIVERY SYSTEM

(75) Inventors: Petr Peterka, San Diego, CA (US); James P. Ashley, Naperville, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/271,249

(22) Filed: Nov. 14, 2008

(51) Int. Cl. H04N 7/173; H04N 7/26

(52) U.S. Cl. 725/87; 386/124; 386/E05.001

(57) ABSTRACT

A method is provided for offering for purchase supplemental content associated with a multimedia program. The method includes receiving over a content delivery system a multimedia program and supplemental content associated with the program. While the program is being rendered, an option is presented to a user to acquire the supplemental content.

### FIELD OF THE INVENTION

The present invention relates generally to content delivery systems, and more particularly, to a system and method for purchasing a supplemental content file such as a soundtrack that is associated with a movie or other program that is delivered over a content delivery system such as a cable or DSL network.

### BACKGROUND OF THE INVENTION

Digital video recorder (DVR) systems are becoming increasingly popular with consumers. Digital video recorder systems use magnetic hard disk drives rather than magnetic cassette tapes to store video programs received from coaxial cable, a satellite dish, an antenna for terrestrial radio frequency signals, or a modem that permits access to content from the Internet. For example, the ReplayTV™ recorder and the TiVO™ recorder record television programs in digital formats on hard disk drives using, for example, MPEG-2 compression. Also, some DVR systems may record on a readable/writable digital versatile disk (DVD) rather than a magnetic disk. Users may schedule programs to be recorded and may play back the recorded programs at a later time. These systems also record what users are watching in real-time, allowing users to pause real-time programs when, for example, the user must leave the room. The systems may continue recording and storing the program being broadcast while the displayed program is paused. Users may resume their viewing where they left off, and may fast forward until they reach the point at which the program is currently being provided.

Often when one views a program such as a motion picture, one might enjoy the soundtrack associated with the motion picture and be inclined to purchase such a soundtrack. However, in general the motion picture viewer is rarely presented with an immediate opportunity to purchase the soundtrack and may lose interest by the time a purchase opportunity presents itself. Thus, opportunities for sale of the soundtrack content may be missed. Similar opportunities may exist for sale of other audio or video portions of a program, for example the purchase of a theme song from a television program or the purchase of a music selection featured in a music video.

### SUMMARY

In accordance with one aspect of the invention, a method is provided for offering for purchase supplemental content associated with a program. The method includes receiving over a content delivery system a multimedia program and supplemental content associated with the program. While the program is being rendered, an option is presented to a user to acquire the supplemental content.

In accordance with another aspect of the invention, an apparatus is provided for rendering a program. The apparatus includes a receiver/tuner for receiving over a content delivery system a multimedia program and supplemental content associated with the program. A computer-readable storage medium is provided for storing the multimedia program and the supplemental content. The apparatus also includes a processor operatively associated with the receiver/tuner and the storage medium. The processor is configured to present to a user an option to acquire the supplemental content while the program is being rendered.

In accordance with another aspect of the invention, a method is provided for delivering a segment of a supplemental content file associated with the multimedia program. The method includes transmitting over a content delivery system a multimedia program, wherein the program includes (i) metadata associating at least one segment of the program with at least one corresponding segment in a supplemental content file associated with the multimedia program and (iii) at least one interactive icon presenting to a viewer an option to purchase the corresponding segment in the supplemental content file while the program is being rendered. A request to purchase at least the corresponding segment is received over the content delivery system. Selected digital rights to the corresponding segment are transferred in accordance with a digital rights management scheme after completion of a purchase transaction.

### BRIEF DESCRIPTION OF THE DRAWINGS

FIG. 1 is one example of a system architecture that can be used to deliver content to a user for recording on a DVR system.

FIG. 2 is a block diagram of one example of the DVR system.

FIG. 3 shows one example of the headend depicted in FIG. 1.

FIG. 4 shows an example of a program stream with supplemental content.

FIG. 5 is flowchart showing one example of a process that may be performed by a DVR system to acquire a supplemental content file that is associated with a multimedia program.

### DETAILED DESCRIPTION

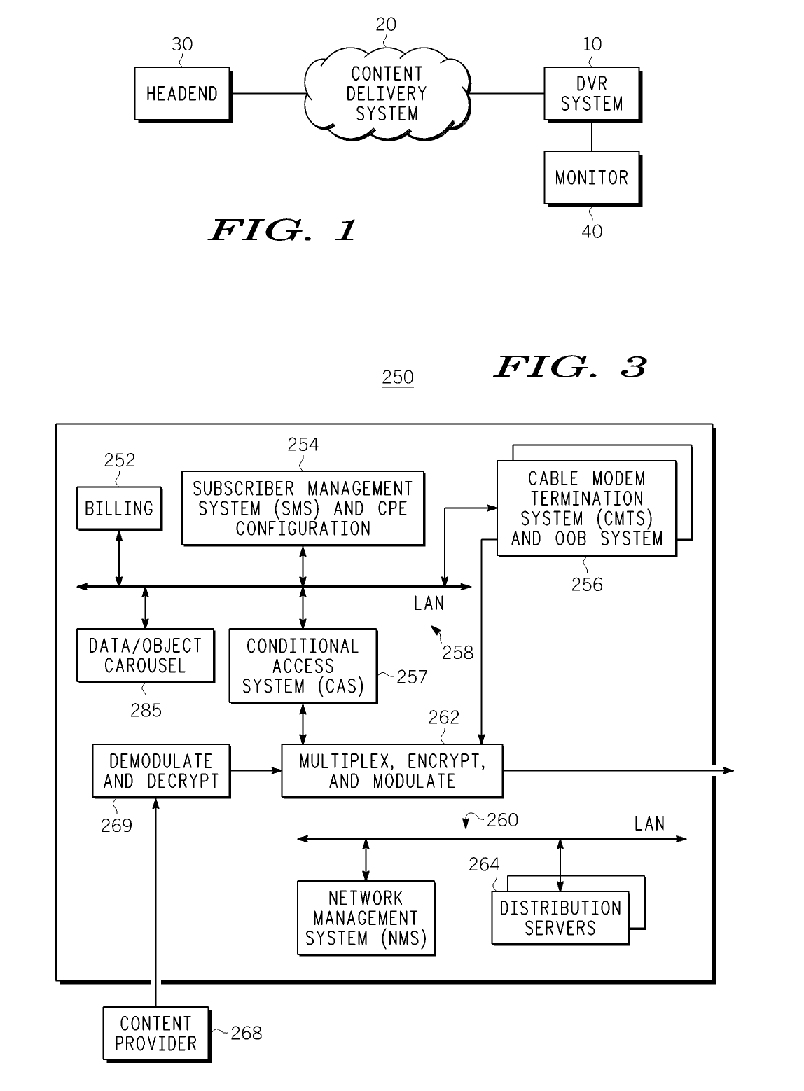

FIG. 1 is one example of a system architecture that can be used to deliver content to a user for recording on a DVR. The system includes a DVR system 10 that stores content received from a headend 30 over a content delivery system 20. A viewing monitor 40 is coupled to DVR system 10, and displays content received by DVR device 10 from content delivery system 20.

It should be understood by those skilled in the art that, although the DVR system 10 is described as being implemented in connection with a DVR subsystem of a set-top terminal, the invention also may be implemented for use in a stand alone DVR device that is network enabled. In addition, those skilled in the art will realize that the invention may be implemented in connection with other types of video rendering devices including a stand-alone portable device or it may be incorporated in other devices, both portable and non-portable, such as a television, personal computer, PDA, and the like.

Illustrative examples of the content delivery system 20 include, but are not limited to, broadcast television networks, cable data networks, xDSL (e.g., ADSL, ADLS2, ADSL2+, VDSL, and VDSL2) systems, satellite television networks and packet-switched networks such as Ethernet networks, and Internet networks. In the case of a cable data network, an all-coaxial or a hybrid-fiber/coax (HFC) network may be employed. The all-coaxial or HFC network generally includes an edge QAM modulator and a hybrid fiber-coax (HFC) network, for example. The edge modulator receives Ethernet frames that encapsulate transport packets, de-capsulate these frames and removes network jitter, implements modulation and, performs frequency up-conversion and transmits radio frequency signals representative of the transport stream packets to end users over the HFC network. In the HFC network, the transport stream is distributed from the headend 30 (e.g., a central office) to a number of second level facilities (distribution hubs). Each hub in turn distributes carriers to a number of fiber nodes. In a typical arrangement, the distribution medium from the head-end down to the fiber node level is optical fibers. Subscriber homes are connected to fiber hubs via coaxial cables.

In the case of a packet-switched network, any suitable network-level protocol may be employed. While the IP protocol suite is often used, other standard and/or proprietary communication protocols are suitable substitutes.

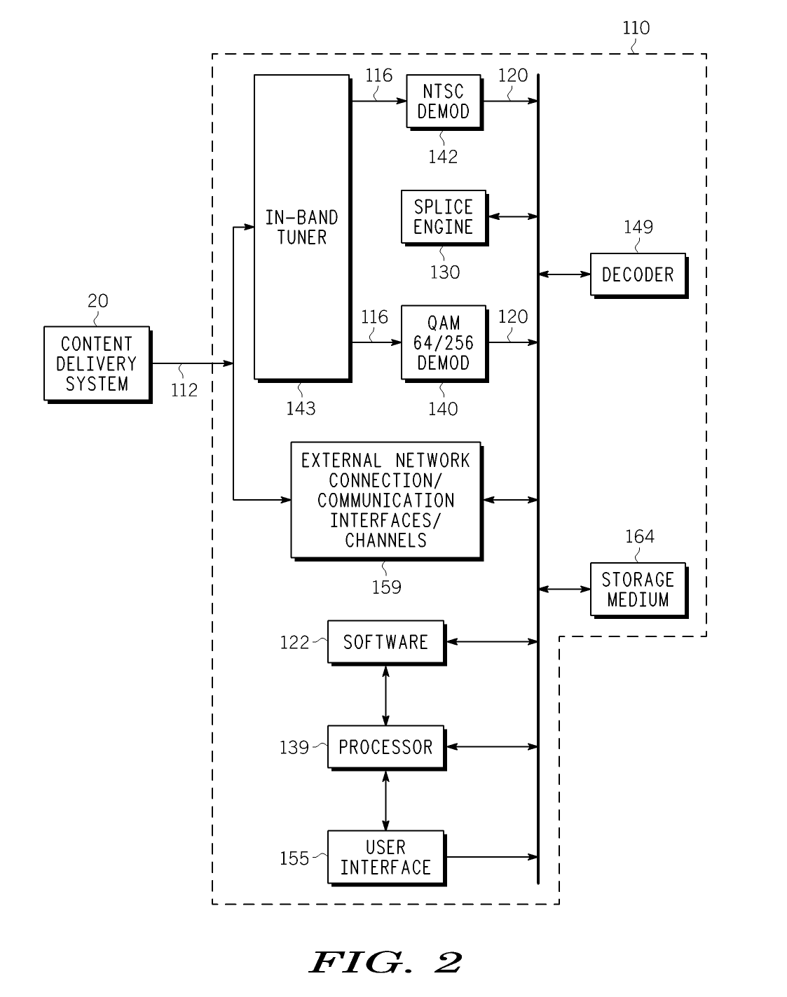

FIG. 2 is a block diagram of one example of the DVR system 10. System 10 receives video signals 112 in which programming content is embodied over the content delivery system 20. DVR system 10 includes external network connection/communication interfaces 159, which support devices such as modems, streaming media players and other network connection support devices and/or software, coupled through local or wide area networks (not shown) to program providers and providers of other content, such as advertising content. DVR system 10 further includes an in-band tuner 143, which tunes to a channel signal 116 selected by a viewer via user interface 155. User interface 155 may be any type of known or future device or technology allowing the consumer to select channels or programs the consumer wishes to receive, such as a remote control, mouse, microphone, keyboard, or touch-screen display associated with a digital video recorder.

Channel signal 116 includes video and/or audio components. Demodulators 140 and 142 are responsive to in-band tuner 143. Demodulator 140, which may be a 64/256 quadrature amplitude modulation demodulator, for example, is responsive to receive a digital version of channel signal 116. Demodulator 140 identifies digital data packets from one or more digital sources, such as a Moving Pictures Experts' Group (MPEG) transport stream, a high-definition television stream, or a media stream from an external network connection 159, such as a cable modem, using well-known methods and techniques. Demodulator 142, which may be an NTSC demodulator, for example, is responsive to receive an analog version of channel signal 116 and to decode signals and markers according to well-known methods and techniques. Demodulators 140 and 142 are operative to output video information 120.

Video information 120 includes compressed video or audio data, arranged for formatting in accordance with a predetermined media format. For instance, video information 120 may be arranged in accordance with an MPEG media format, such as the MPEG-2 media format, but may be arranged in accordance with other media formats, including but not limited to other MPEG formats, H.261, or H.263, or H.264, or VC1 formats.

Storage medium 164 is responsive to receive, among other things, encoded video signal 120 for storage. Storage medium 164 may be any local or remote device, now known or later developed, capable of recording data, including but not limited to a hard disk drive, a videocassette recorder tape, all types of optical storage media such as compact disks and digital videodisks, a magnetic tape, a home router, or a server.

Decoder 149 is responsive to receive recorded encoded video signal 120 from storage medium 164, and to play back recorded encoded video signal 120 via display device 40 (see FIG. 1), in response to instructions from user interface 155. Decoder 149 is also responsive to receive and pass through video programming directly from tuner 143. Internal arrangements of decoder 149 are well known—decoder 149 may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Processor 139 and software 122 are illustrated functionally, and are responsive to various elements of DVR system 10, including demodulators 140 and 142, storage medium 164 and decoder 149. When loaded into a processor, such as processor 139, software 122 is operative to control encoding, recording and playback of encoded video signal 120. It will be appreciated, however, that aspects of the DVR system are not limited to any specific embodiments of computer software or signal processing methods. For example, one or more processors packaged together or with other elements of DVR system 10 may implement functions of processor 139 in a variety of ways. It will also be appreciated that software 122 may be any stored instructions, in one or more parts (stored, for example, on storage medium 164, or another internal or external storage medium such as a read-only-memory or a random-access memory) electronically controlling functions provided by DVR system 10, including firmware, and may be used or implemented by one or more elements, including one or more processors, of DVR system 10.

During normal operation of the DVR system 10, a viewer using user interface 155 selects a particular program to be recorded from the headend and/or selects a recorded program for playback from storage medium 164. When a program is to be recorded, an encoded video signal 120 associated with the selected program is transferred to storage medium 164. Likewise, when a program is to be played back, an encoded video signal 120 associated with the selected program is transferred from storage medium 164 to decoder 149 for processing. Decoder 149 demultiplexes and decodes encoded video signal 120 for presentation to the consumer via the display device or monitor.

FIG. 3 shows one example of the headend 30 depicted in FIG. 1. As shown, the headend architecture 250 comprises typical head-end components and services including billing module 252, subscriber management system (SMS) and client device configuration management module 254, cable-modem termination system (CMTS), (out-of-band) OOB system 256 and data or object carousel 285, as well as LAN(s) 258 and 260 for placing the various components in data communication with one another. It will be appreciated that while a bar or bus LAN topology is illustrated, any number of other arrangements (e.g., ring, star, etc.) may be used. The headend receives content from a content provider 268. The content is received by a demodulator and decryptor 269 in the headend. Distribution servers 264, which are coupled to the LAN 260, store the objects that are to be downloaded to the DVR system 10 of FIG. 1.

The architecture 250 of FIG. 3 further includes a multiplexer/encrypter/modulator (MEM) 262 coupled to the content delivery system 20 (via a conditional access system 257) and the demodulator and decryptor 269. The MEM 262 is adapted to “condition” content for transmission over the content delivery system 20. In a typical distribution network, information is carried across multiple channels. Thus, the head-end must be adapted to acquire the information for the carried channels from various sources. Typically, the channels being delivered from the headend 250 to the DVR system 10 (“downstream”) are multiplexed together in the headend. It will also be appreciated that the head-end configuration depicted in FIG. 3 is a high-level, conceptual architecture and that each network may have multiple head-ends deployed using different architectures.

The content provider 268 has a content database containing a selection of programs that can be delivered to the headend 250, which is in turn transmitted to the DVR system 10 by, for example, broadcasting, unicasting, or multicasting a digital service such as, but not limited to, a conventional broadcast, a video-on-demand (VOD) or a switched digital video (SDV) service. As previously mentioned, the programs may be transmitted to the DVR system with an additional or supplemental content file such as the soundtrack 420 to the motion picture. More generally, the supplemental content file may contain any audio and/or video content, and/or other data such as CD cover art, lyrics, coupons, promotion material, movie trailers and the like . . . that is associated with the program with which it is delivered. For instance, instead of, or in addition to, a soundtrack 420, the supplemental content file may contain other material such as music videos or the like which do not appear in the program itself The programs may be packaged with the supplemental content file with which they are respectively associated by the content provider, a content distributor, or the service provider such as a multi-service operator (MSO). The DVR system may automatically record or otherwise store the supplemental content while the user watches the motion picture or other program.

Once a user of the DVR system 10 has viewed the program, the user may be provided with an option to purchase (or otherwise acquire rights) the supplemental content file. In the event that the supplemental content file is the program's soundtrack, all of the music and other audio content associated with a conventional soundtrack recording, as might be purchased in the form of a compact disc or saved in any suitable digital format such as MP3, ATRAC, AAC, any of the MPEG standards, etc., is available in an appropriate format(s) after the program has been viewed or stored on the DVR system 10. Thus, for example, upon viewing the program or upon determining that he or she wishes to purchase the soundtrack, the user can do so immediately. The user may be invited to obtain the supplemental content while watching the program, after the program ends, when watching the program after it has been recorded, and/or when the program is being deleted from the DVR system 10. In this manner, the likelihood of selling the supplemental file is enhanced. In some cases if the user rejects the offer, the DVR system may automatically delete the supplemental content. Alternatively, the DRV system may delay deletion of the supplemental content until the program is deleted from the DVR system.

In some implementations the supplemental content file associated with the program may be delivered to the DRV system 10 in the same transport stream (e.g., an MPEG transport stream) that is used to deliver the program itself. This may be accomplished, for example, using a data or object carousel (e.g., data or object carousel 285 shown in FIG. 3) in accordance with a protocol such as the Digital Storage Media Command and Control (DSMCC) protocol. A full description of the DSMCC specification may be found in ISO/IEC 13818-6. Within a DSMCC carousel data is structured into modules. The DSMCC modules and the program are transmitted in a common transport stream. The DSMCC data/object carousel defines how and when to send modules containing applications or other data in the transport stream together with the audio-visual content down a broadcast channel. All files are repeatedly sent all the time, e.g. once every 10 seconds. That is, the carousel provides a transport mechanism that allows a server in the headend to present a set of data modules by cyclically repeating the content of the modules one or more times. The DSMCC modules may include data, files, applications and other content of any type in any format. Accordingly, such modules may be used to transport the soundtrack 420 or other supplemental content file associated with a program that is being delivered in a transport stream such as an MPEG transport stream.

Each DSMCC module is divided up to form a payload of one or more download data messages each defined using the DSM-CC DownloadDataBlock syntax. The number of such download data messages depends on the size of the module and the maximum payload of each download data message. Information describing each module and any logical grouping is provided by download control messages, defined using either the DSMCC DownloadServerInitiate or DownloadInfoIndication syntaxes as appropriate.

In those implementations that employ a data or object carousel, the supplemental content may or may not be repeatedly delivered to the DVR system 10. That is, the supplemental content may be streamed just once or periodically while the program is being delivered. If the content delivery system 20 is an IP network, other mechanisms may be used to deliver the supplemental content. For instance, a supplemental URL/URI may be included with the motion picture or other program, which directs the DVR system to the supplemental content when it is requested to do so by the user.

In some cases, instead of using a data carousel or other technique to incorporate the soundtrack 420 in the same transport stream as the program, the program and the soundtrack 420 may be transmitted in separate transport streams. One disadvantage of this approach, however, is that the DVR system will be required to tune to the two different streams at the same time, which is a capability that is available in some but not all DVR systems or set top boxes.

Purchase and storage of the supplemental content file associated with the program may be carried out in any number of ways. For convenience, the following discussion will assume that the supplemental content file is the soundtrack 420 to a program such as a motion picture. However, it should be noted that this discussion is equally applicable to other types of supplemental content that may be delivered to a user along with a program. In one example, at the end of the program the user is given the option to purchase the soundtrack 420 by presenting an on-screen interactive icon through which the transaction may be accomplished. In some cases the interactive icon may be presented to the user at the beginning and/or during the program. Moreover, instead of purchasing the entire soundtrack, the user may be given the option to purchase selected portions of the soundtrack 420 such as individual songs. In this case an on-screen interactive icon that allows a particular song to be purchased may be presented to the user when that song is being played during the course of the program. By providing the user with the option to purchase the song while it is being presented in the program, the user may be more inclined to make the purchase. The interactive icon may appear as an overlay on the top or bottom portion of the screen. The interactive icon may also provide additional information such as the song title, artist, and the like. The user may select the icon through the user interface 155 shown in FIG. 2.

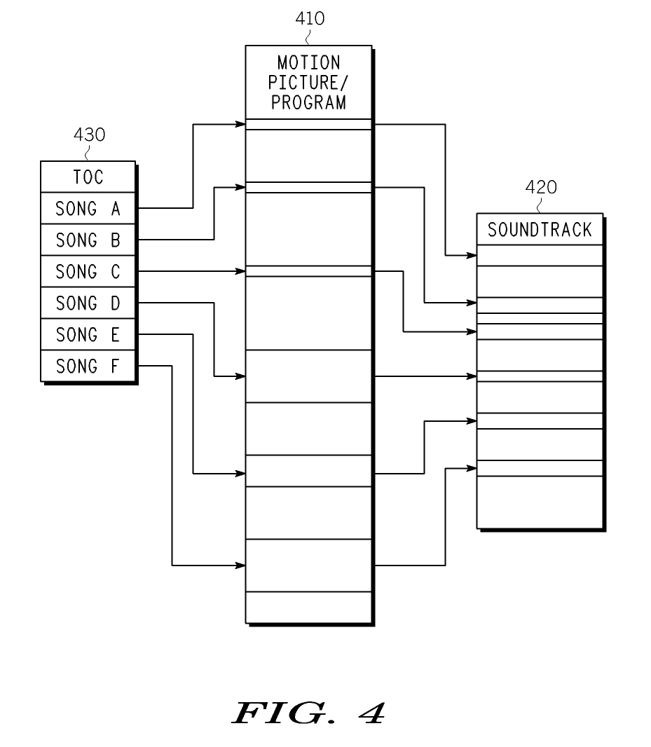

To assist the user in purchasing individual songs or other portions of the soundtrack 420, the program may include metadata describing the soundtrack. In one example, the aforementioned interactive icons may be included in the program as metadata or as an interactive application such as a so-called xlet application that is employed in the Open Cable Application Platform (OCAP). Similar interactive applications also may be used in connection with other standard platforms (e.g. DVB MHP) or proprietary platforms. Other metadata that may be included with the program are graphics and text describing the soundtrack 420 (equivalent to a CD cover). As another example of metadata, the program may include a table of contents (TOC) such as the TOC 430 shown in FIG. 4. In this example the picture and the soundtrack 420 are shown conceptually as a transport stream 410 and a carousel with two files 420 and 430. Each entry in the TOC 430 points to a segment of data in the program 410 and its corresponding segment in the soundtrack 420. The user can selectively purchase individual songs by selecting individual entries in the TOC 430. When the user completes the transaction to acquire an individual song indexed by the TOC 430, the segments in the soundtrack 420 to which the TOC 430 points are extracted and stored. The TOC 430 may point to packet numbers, time stamps, or other identifiers as dictated by the specific technology employed to encode the program and the soundtrack. Thus, whatever technology is employed, the content provider or the service provider may designate specific portions of the soundtrack 420 that can be acquired.

Additional metadata that may be included in the program is metadata that is used to make the DVR system aware of the existence of the supplemental content and metadata that instructs the DVR system to store the supplemental content. Other types of metadata may be provided to indicate the format or formats in which the supplemental content is available, to facilitate purchase of the supplemental content, and so on.

The soundtrack, or individual songs therein, may be delivered to the DVR system 10 in a single format or multiple formats. As previously mentioned, examples of such formats include MP3, ATRAC, and AAC. For instance, if the user intends to transfer the soundtrack 420 from the DVR system to an MP3 audio player, then the soundtrack 420 may be delivered in at least an MP3 format. In some cases the supplemental file may be delivered in all available formats so that the user will have maximum flexibility in choosing a rendering device on which to store and play the soundtrack. Of course, in the more general case of a supplemental content file, the file may be delivered in one or more formats suitable for rendering content of the type contained in the file.

In the event that fewer than all the available formats are to be delivered to the DVR device, the user may complete an entry in the setup menu of the DRV device to select which format(s) is desired. The DVR will store this information in its user settings/preferences database and use it as appropriate to tune to and record the desired subset of the supplemental format(s).

The user may be provided with the option to purchase the supplemental content file in the manner described above while viewing the program in real-time as it is being received from the headend. In addition, the user may also be provided with the same option if viewing it at a later time after it has been recorded to the DVR system or even at the time the user is about to the delete the program from the DVR system. Regardless of whether the program is recorded for later viewing, the supplemental content file will generally be downloaded to the DVR system. If the user declines to purchase the supplemental content file, in some implementations the supplemental content file may be immediately erased or otherwise deleted from the DVR system. In other implementations, however, the supplemental content file may remain on the DVR system, either indefinitely or for some predetermined period of time, in the event that the user subsequently changes his or her mind. In yet other implementations, the supplemental content file may only be downloaded from the headend to the DVR system when the user elects to make a purchase. In this case only the metadata (e.g., the interactive icons, the TOC) associated with the supplemental content file may be downloaded in the same transport stream as the program.

In many cases it will be necessary to restrict the rights that the user may acquire in the supplemental content file. For this purpose a transfer of rights to the supplemental content file may be performed in accordance with a Digital Rights Management (DRM) system. The DRM system specifies the nature of the rights the user may acquire in the supplemental content file. The term “purchase” as used herein, generally refers to rights acquired as a result of completing a transaction that may be restricted by a DRM system.

By way of example, and not limitation, the DRM system may specify that a user can, in exchange for compensation, “play” the content or portion thereof a specific number of times before the content or portion thereof expires. As another example, the DRM system may specify that a user can play the content or portion thereof an unlimited number of times for a particular defined period of time before the content or portion thereof expires. In yet another example, the DRM system may specify that a user can play the content or portion thereof an unlimited number of times without the content or portion thereof ever expiring. In other examples the DRM system can specify a number of copies that can be made of the content or the number of machines the content can reside upon. Once the user's rights in the supplemental content file has expired, the file is disabled in some suitable manner.

The DRM system may be implemented in accordance with techniques well known to those of ordinary skill in the art. For instance, the supplemental content file may be encrypted and the headend may deliver a decryption key to the DVR system for decryption. In some cases the DRM system that is employed may be the native DRM system that is used between the headend and the DVR system. Such a DRM system is often implemented by a conditional access system of the type used by cable television operators. If the native DRM system is employed, however, the user may not be able to transfer the supplemental content file from the DVR system to another rendering device. Alternatively, the supplemental content may be protected by a DRM system that allows the user to copy or move the content from the DVR system to another device such as a portable media player (PMP). The user may have an option to purchase individual parts or segments (e.g., songs) of the supplemental content or the user may have previously subscribed to a service that allows access to the supplemental content. In the latter case, no purchase transaction back to the headend will generally be required.

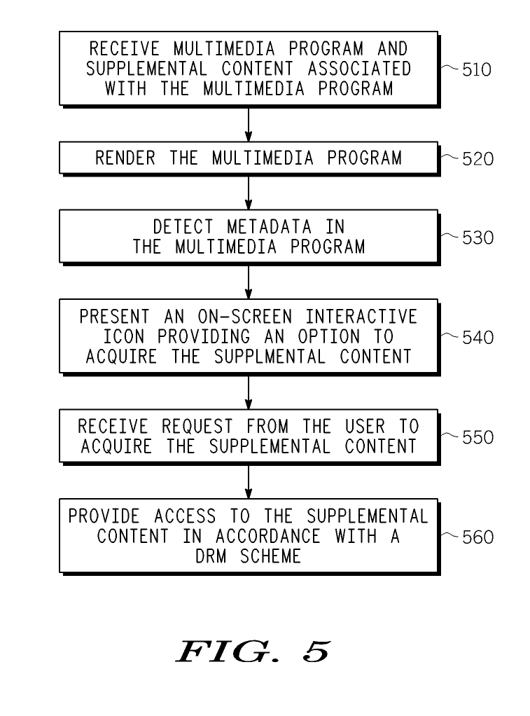

FIG. 5 is flowchart showing one example of a process that may be performed by a DVR system to acquire a supplemental content file that is associated with a multimedia program. The process begins in step 510 when the DVR system receives over a content delivery system a multimedia program and supplemental content associated with the program. The program begins to be rendered in step 520. While the program is being rendered metadata is detected in the program in step 530. The metadata causes the DVR system to present an on-screen interactive icon to the user. The interactive icon provides the user with the option to purchase or otherwise acquire the supplemental content in step 540. In step 550 the DVR system receives a request from the user to acquire the supplemental content. The request may specify one or more formats in which the supplemental content is to be acquired. Finally, in step 560 the user is provided access to the supplemental content file by transferring the appropriate rights in accordance with a digital rights management scheme.

The processes described above, including but not limited to process depicted in FIG. 5, may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, and silicon memory (e.g., removable, non-removable, volatile or non-volatile).

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method of offering for purchase supplemental content associated with a program, comprising:
receiving over a content delivery system a multimedia program and supplemental content associated with the program;
rendering the program; and
presenting to a user an option to acquire the supplemental content while the program is being rendered.

2. The method of claim 1 wherein the program and the supplemental content are received in a common transport stream.

3. The method of claim 2 wherein the supplemental content is received as an object in accordance with a carousel protocol.

4. The method of claim 1 wherein the supplemental content is a soundtrack to the program.

5. The method of claim 1 wherein the supplemental content is received in a plurality of different formats.

6. The method of claim 5 further comprising receiving a request to acquire the supplemental content in at least one format selected from among the plurality of formats.

7. The method of claim 1 wherein the supplemental content is received in at least one format preselected by the user.

8. The method of claim 1 wherein the option to acquire the supplemental content is presented to the user as an onscreen interactive overlay while the program is being rendered.

9. The method of claim 1 further comprising presenting to the user an option to acquire a segment of the supplemental content.

10. The method of claim 9 wherein the supplemental content is a soundtrack to the program and the segment is a song and further comprising presenting the option to purchase the song by presenting an onscreen interactive overlay while the song is being rendered during the program.

11. The method of claim 1 further comprising receiving a request to acquire the supplemental content and presenting a user access to the supplemental content in accordance with a digital rights management scheme.

12. The method of claim 1 wherein the supplemental content is received over the content delivery system after the user completes a transaction to acquire the supplemental content.

13. The method of claim 1 further comprising:
storing the program and the supplemental content upon receipt; and
rendering the program after it has been stored.

14. The method of claim 1 further comprising:
detecting metadata in the program indicting an existence of the supplemental content; and
detecting metadata in the program that causes the option to acquire the supplemental content to be presented to the user.

15. At least one computer-readable medium encoded with instructions which, when executed by a processor, performs a method including:
transmitting over a content delivery system a multimedia program, wherein the program includes (i) metadata associating at least one segment of the program with at least one corresponding segment in a supplemental content file associated with the multimedia program and (iii) at least one interactive icon presenting to a viewer an option to purchase the corresponding segment in the supplemental content file while the program is being rendered;
receiving over the content delivery system a request to purchase at least the corresponding segment; and
transferring selected digital rights to the corresponding segment in accordance with a digital rights management scheme after completion of a purchase transaction.

16. The computer-readable medium of claim 15 wherein the multimedia program is transmitted to a DVR system and the multimedia program further includes metadata instructing the DVR system to record the supplemental content file.

17. The computer-readable medium of claim 15 further comprising transmitting the supplemental content file over the content delivery system in at least one format preselected by a recipient of the supplemental content file.

18. An apparatus for rendering a program, comprising:
a receiver/tuner for receiving over a content delivery system a multimedia program and supplemental content associated with the program;
a computer-readable storage medium for storing the multimedia program and the supplemental content; and
a processor operatively associated with the receiver/tuner and the storage medium and configured to present to a user an option to acquire the supplemental content while the program is being rendered.

19. The apparatus of claim 18 wherein the supplemental content is a soundtrack to the program.

20. The apparatus of claim 18 wherein the supplemental content is received in a plurality of different formats.
